(19) United States
(12) Patent Application Publication
(10) Pub. No.: US 2020/0098395 A1
(43) Pub. Date: Mar. 26, 2020

(54) VIDEO EDITING APPARATUS

(71) Applicant: FUJI XEROX CO., LTD., TOKYO (JP)

(72) Inventors: Zhihua ZHONG, Singapore (SG); Nick Yu Soon SU, Singapore (SG); Delphine OW, Singapore (SG); Vincent Tze Bing TANG, Singapore (SG); Sarah Shuang BAI, Singapore (SG)

(73) Assignee: FUJI XEROX CO., LTD., TOKYO (JP)

(21) Appl. No.: 16/261,479

(22) Filed: Jan. 29, 2019

(30) Foreign Application Priority Data
Sep. 25, 2018 (JP) 2018-178307

(51) Int. Cl. G11B 27/036; G06K 9/00

(52) U.S. Cl. CPC G11B 27/036; G06K 9/00288

(57) ABSTRACT

A video editing apparatus includes a recognition unit that recognizes a target that is captured in a video for a time period, a registration unit that registers therein the target, recognized by the recognition unit, in association with the time period, and a display that displays, in response to reception of information, an image in which the target associated with the time period and identified by the information is recognized.

### CROSS-REFERENCE TO RELATED APPLICATIONS

This application is based on and claims priority under 35 USC 119 from Japanese Patent Application No. 2018-178307 filed Sep. 25, 2018.

### BACKGROUND

### (i) Technical Field

The present disclosure relates to a video editing apparatus.

### (ii) Related Art

Japanese Unexamined Patent Application Publication No. 2010-268195 discloses a video content editing program. Video content is time-sequentially segmented into multiple content objects. Each content object includes multiple pieces of tag information related thereto. The video content editing program includes the pieces of information. The video content editing program causes a computer to function as a user interface controller and a content generation unit. The user interface controller displays a first time line of multiple content objects including first tag information in parallel with a second time line of a content object not including the first tag information. The content generation unit links content objects on a per time line basis.

A report with an image concerning a target in a video may be generated. Selecting the target image from the video may not be easy and may lead to an increase in a burden on a person who generates the report.

### SUMMARY

Aspects of non-limiting embodiments of the present disclosure relate to reducing the burden on a person who generates a report using an image including a target.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a video editing apparatus. The video editing apparatus includes a recognition unit that recognizes a target that is captured in a video for a predetermined time period, a registration unit that registers the target, recognized by the recognition unit, in association with the predetermined time period, and a display that displays, in response to reception of information, an image in which the target associated with the predetermined time period and identified by the information is recognized.

### BRIEF DESCRIPTION OF THE DRAWINGS

Exemplary embodiment of the present disclosure will be described in detail based on the following figures, wherein:

FIG. 1 is a block diagram illustrating the configuration of a video editing apparatus of an exemplary embodiment;

FIG. 2 is a block diagram illustrating the function of a server;

FIG. 3 is a flowchart illustrating a registration process performed for a registration unit;

FIG. 4 is a flowchart illustrating an additional registration process performed by an additional registration unit;

FIG. 5 illustrates registration to the registration unit;

FIGS. 6A and 6B illustrate states subsequent to a face recognition process, wherein FIG. 6A illustrates a state in which faces are recognized, and FIG. 6B illustrates a state in which additional registration is performed;

FIG. 7 is a flowchart illustrating a table creation process performed by a table creation unit;

FIG. 8 illustrates an example of a table;

FIG. 9 is a flowchart illustrating a process performed by a report generation assisting unit; and

FIG. 10 illustrates an example of a report generation assisting process.

### DETAILED DESCRIPTION

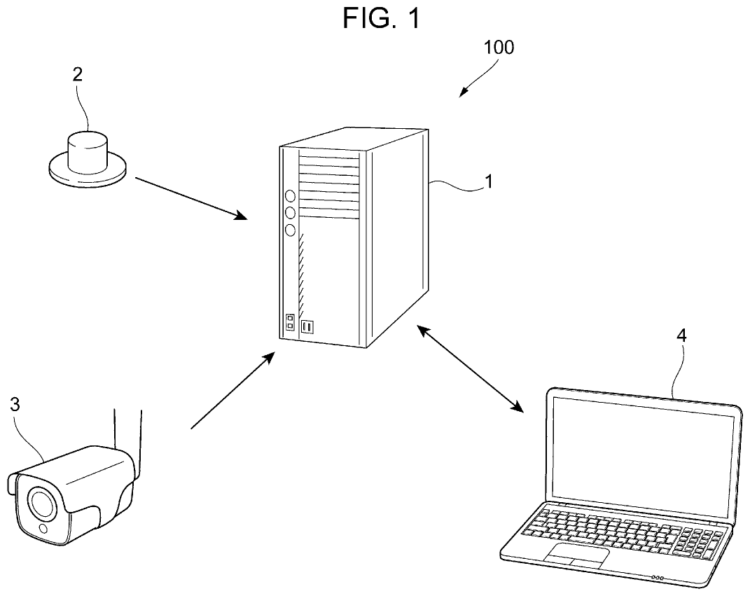

An exemplary embodiment of the disclosure is described in detail with reference to the drawings. FIG. 1 is a block diagram illustrating the configuration of a video editing apparatus 100 of the exemplary embodiment. The video editing apparatus 100 of FIG. 1 is deployed in a school, for example, to be used for school education. The video editing apparatus 100 includes a server 1. The server 1 is connected for communication to an instruction device 2, such as a portable button device, a camera 3 that photographs the behavior of each student who takes a lesson in a class room, and a personal computer (PC) 4 that creates and edits a report for each student by displaying the image captured by the camera 3 and by using the displayed image.

Each of the server 1 and the PC 4 includes a central processing unit (CPU) that performs arithmetic operations by executing software programs, a random-access memory (RAM), a read-only memory (ROM), a display, an input device that inputs to the PC 4, and the like. Each of the server 1 and the PC 4 may be a single computer, or may be implemented through distributed processing performed by multiple computers.

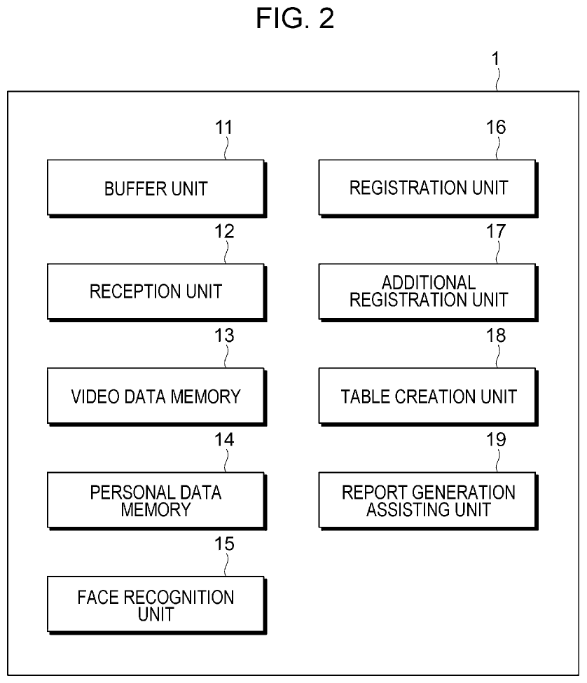

FIG. 2 is a functional block diagram of the server 1. The server 1 of FIG. 2 includes a buffer unit 11 that temporarily stores an image captured by the camera 3, a reception unit 12 that receives an instruction from the instruction device 2, a video data memory 13 that stores video data at or close to the time of the reception of the instruction when the reception unit 12 has received the instruction from the instruction device 2. The server 1 holds the images captured by the camera 3, deletes an older captured image over elapsed time, and thus successively stores a newly captured image on the buffer unit 11. When the reception unit 12 receives an instruction from the instruction device 2, some or all of the images stored on the, buffer unit 11 are stored on the video data memory 13 for recording. According to the exemplary embodiment, the storage of the images on the video data memory 13 is not continuously performed. Alternatively, control may be performed such that the storage of the images is continuously performed.

The server 1 also includes a personal data memory 14 that pre-stores personal data of each student that the report is going to be generated about, and a face recognition unit 15 that performs a face recognition process on each frame of the video data stored on the video data memory 13. In the face recognition process, a portion that is recognized as a face within the frame is checked against a face image database of the students to identify each student. The server 1 further includes a registration unit 16, and an additional registration unit 17. The registration unit 16 registers, together with frame information of the video data, student identification information that identifies a student whose face is recognized by the face recognition unit 15. The additional registration unit 17 additionally registers on the registration unit 16 a student whose image is captured in the video data stored on the video data memory 13 but whose face is not recognized in the face recognition process performed by the face recognition unit 15. With the additional registration unit 17, if a person's image is captured in the video but is not recognized by the face recognition unit 15, a user may operate the server 1 to additionally register the person on the registration unit 16.

The personal data refers to data that identifies a school class to which each student belongs. Name information of all students belonging to the school class may be acquired using the personal data. If information indicating the schedule of class sessions of the class and time information are acquired, a school subject of the class session on which the video data is stored on the video data memory 13 may be identified.

The server 1 includes a table creation unit 18 and a report generation assisting unit 19. The table creation unit 18 creates a table that indicates the number of registrations of each of the students on which reports are generated on the registration unit 16 on each piece of the video data stored on the video data memory 13. The report generation assisting unit 19 generates the report on each student, based on the registrations on the registration unit 16.

The face recognition unit 15 is an example of a recognition unit, and has a recognition function. The registration unit 16 is an example of a registration unit, and has a registration function. The PC 4 is an example of a display, and has a display function. The student identification information is an example of information that the display receives. The report generation assisting unit 19 is an example of a selection unit. The table creation unit 18 is an example of a presentation unit, and has a presentation function. The additional registration unit 17 is an example of an addition unit, and has an addition function.

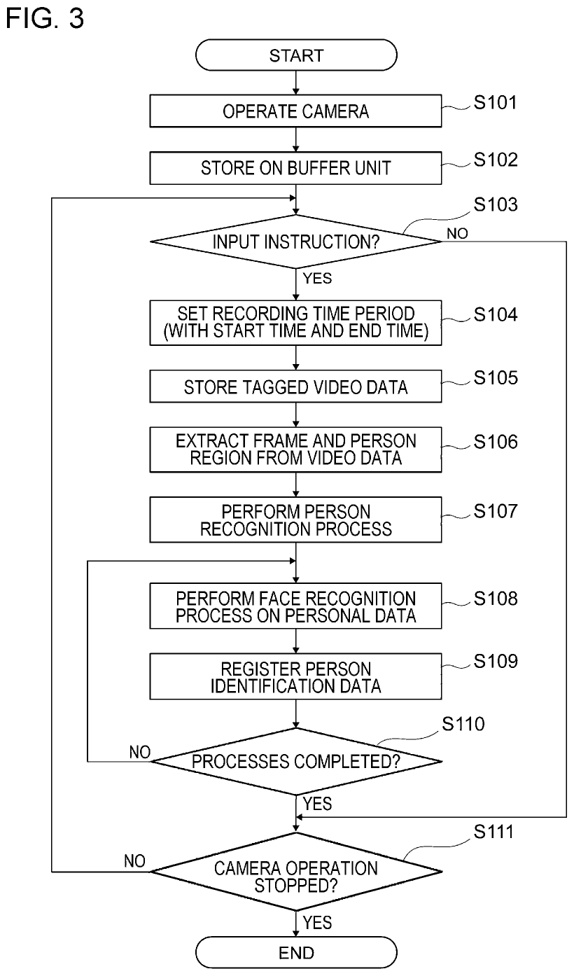

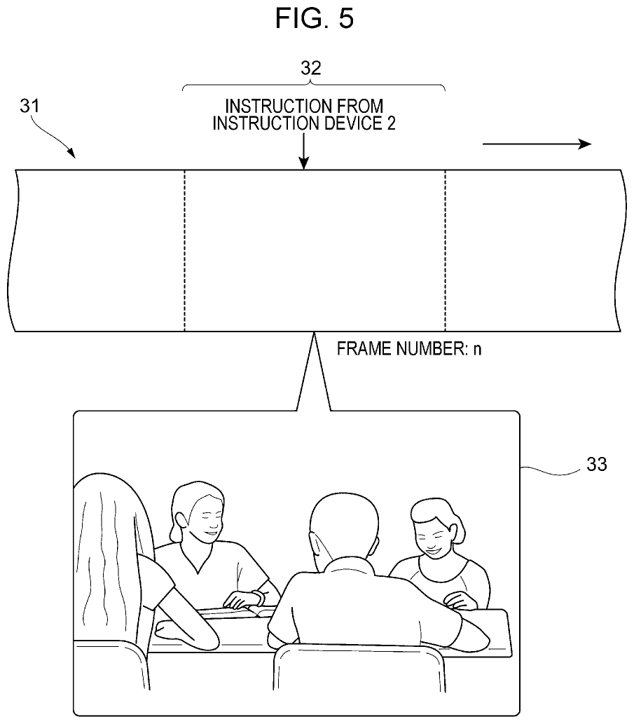

FIG. 3 is a flowchart illustrating the registration process performed for the registration unit 16. In the example of the registration process of FIG. 3, the captured images are continuously stored onto the buffer unit 11 in the server 1 (S102) while the camera 3 operates (S101). Upon receiving an input instruction from the instruction device 2 (yes branch from S103), the reception unit 12 sets a recording period or a specific period (S104). The reception unit 12 stores on the video data memory 13 the video data of the set recording period as video data having tag information (see tagged video data 32 illustrated in FIG. 5) (S105).

The server 1 finds from the personal data a student captured by the camera 3, extracts a frame (see a frame 33 of FIG. 5) from the tagged video data, extracts a person region from the extracted frame (S106), and performs a person identification process (S107) to determine whether the student is the one captured in the personal data. The face recognition unit 15 performs a face recognition process using the same personal data (S108). The student identification information identifying the face-recognized student is registered together with a frame number in the tagged video data (see a frame number n of FIG. 5) on the registration unit 16 (S109). Steps S108 and S109 are repeated as appropriate (S110). In this way, the user may understand a student who has been face-recognized and a location in the tagged video data where the student has been face-recognized. If no input instruction has come from the instruction device 2 (no branch from S103), the server 1 determines whether the camera 3 has been stopped (S111). If the camera 3 has not been stopped (no branch from S111), processing returns to step S103. If the camera 3 has been stopped (yes branch from S111), processing thus ends. According the exemplary embodiment, person region extraction (S106) through person identification data registration (S109) are performed prior to the stopping of the camera operation subsequent to the input instruction. The operations at and after the person region extraction (S106) may be performed at any timing, for example, after the stopping of the camera operation.

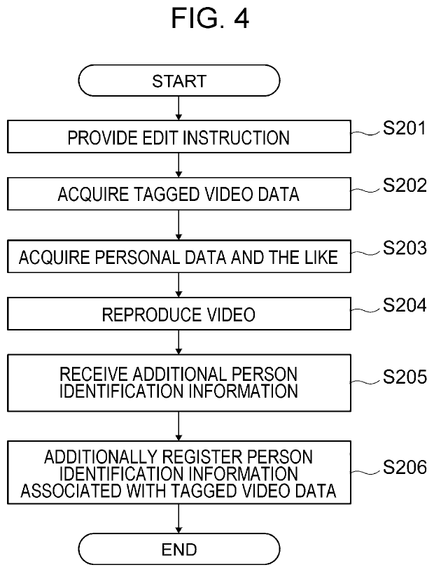

FIG. 4 is a flowchart illustrating an additional registration process performed by the additional registration unit 17. As described above, the student captured in the tagged video data is face-recognized and registered on the registration unit 16. However, a student who is captured in the tagged video data but not face-recognized is not registered on the registration unit 16. According to the exemplary embodiment, the additional registration unit 17 is used to register a student even if his or her face is not recognized. The registration to the registration unit 16 is automatically performed. The additional registration by the additional registration unit 17 is triggered by a user, such as a teacher, who operates the PC 4.

The exemplary embodiment relates to a recognition unit, a registration unit, and an additional registration unit. The recognition unit is an example of the face recognition unit 15 that recognizes a person captured in a video throughout a specific time period. The registration unit is an example of the registration unit 16 that registers the person who is recognized by the recognition unit. The additional registration unit is an example of the additional registration unit 17 that additionally registers a person on the registration unit if the person captured for the specific time period is not recognized by the recognition unit. Also according to the exemplary embodiment, the exemplary embodiment relates to a recognition unit, a registration unit, and an additional registration unit. The recognition unit is an example of the face recognition unit 15 that recognizes a target captured in a video throughout the specific time period. The registration unit is an example of the registration unit 16 that registers the target that is recognized by the recognition unit. The additional registration unit is an example of the additional registration unit 17 that additionally registers on the registration unit a target that is not recognized by the recognition unit for the specific time period.

In the process of FIG. 4, when the reception unit 12 in the server 1 receives an edit instruction from the PC 4 (S201), the server 1 acquires the corresponding tagged video data from the video data stored on the video data memory 13 (S202). The server 1 acquires from the registration unit 16 the student identification information and the frame number of the student identified by the tagged video data (S203). The server 1 reproduces the video, based on the tagged video data, the student identification information, and the frame number (S204). The user may recognize a student who is face-recognized and a frame in which the student is face-recognized by consecutively reproducing the fames of the image of the student identified through face recognition and tagged with a mark. By reproducing the video, the user may recognize students who are photographed but are not face-recognized. The teacher may thus recognize a student whose face is recognized (face recognized student) and a student whose face is not recognized (unrecognized student).

The teacher watching the video reproduced on the PC 4 operates the PC 4 to input information about the unrecognized student in a given frame, and the reception unit 12 in the server 1 receives the information as additional student identification information (S205). The additional registration unit 17 additionally registers on the registration unit 16 the student identification information associated with the frame corresponding to the tagged video data (S206). The unrecognized student is thus handled as an additionally recognized student.

As described above, the registration to the registration unit 16 may be performed by the face recognition unit 15 or may be performed in the additional registration by the additional registration unit 17. The students may be registered on the registration unit 16 in two methods. In a first method, the face recognized student and the additionally recognized student are registered with no difference set therebetween. In the second method, the face recognized student and the additionally recognized student are registered with a difference set therebetween. Any of both methods may be selected in view of the user friendliness in the report generation. The first method reduces the burden on the user because the amount of information is smaller during the report generation in the first method than in the second method. The second method enables the user to perform post-search on a student who is additionally registered. It is contemplated that the user selects one of both prior to the recording. The user may select the display form at the stage of table creation.

If the face recognized student and the additionally recognized student are to be differentiated from each other in the information stored on the registration unit 16, information that differentiates the face recognized student from the additionally recognized student may be registered on the registration unit 16. The “information that differentiates” indicates information that differentiates reasons for the registration on the registration unit 16. The “information that differentiates” may be flag information that differentiates one student from another. The registration unit 16 may be segmented into a region on which the face recognized student is to be registered and a region on which the additionally recognized student is to be registered. Information on the regions may be the “information that differentiates”.

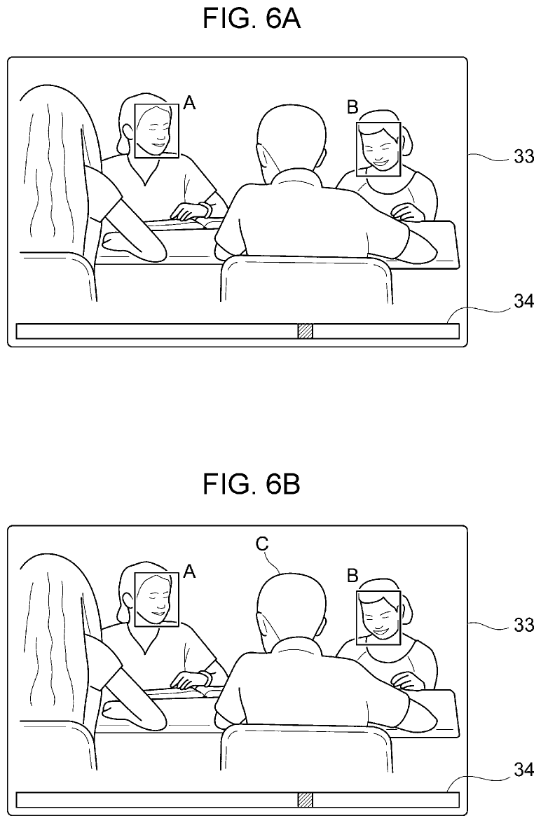

The registration to the registration unit 16 is specifically described. FIG. 5 illustrates the registration to the registration unit 16, and indicates the relationship between the video data and the frame. FIGS. 6A and 6B illustrate states subsequent to a face recognition process. FIG. 6A illustrates a state in which faces are recognized, and FIG. 6B illustrates a state in which additional registration is performed. If an instruction is received from the instruction device 2 with the camera 3 operating as illustrated in FIG. 5, the video data during a time period extending around a time point when the instruction is provided is stored as the tagged video data 32 on the video data memory 13. The tagged video data 32 contains multiple frames, and a frame 33 is tagged with a frame number n, for example. The time period around the time point of the instruction is an example of a predetermined time period in the video.

When the face recognition unit 15 performs the face recognition process on each frame of the tagged video data 32 stored on the video data memory 13, a student A and a student B of the frame 33 are identified as illustrated in FIG. 6A. The student identification information is obtained from the frame number in this way. Conversely, the frame number is obtained from the student identification information. When the PC 4 reproduces the video (see S204) with the additional registration unit 17 performing the additional registration, a reproduce bar 34 is displayed. The reproduce bar 34 indicates elapsed time of the tagged video data. By sliding the reproduce bar 34, another frame may be displayed.

A student C who is not face-recognized is additionally registered by editing, as illustrated in FIG. 6B. The student C's face is not photographed, and is thus not face-recognized. If the teacher determines that the video may be possibly used in the report generation for the student C at the frame 33, the student C may be additionally registered and displayed as illustrated in FIG. 6B. Referring to FIG. 6B, the students A and B who are face-recognized and the student C who is additionally registered are displayed in different display forms, but the students A and B, and the student C may be displayed in the same display form.

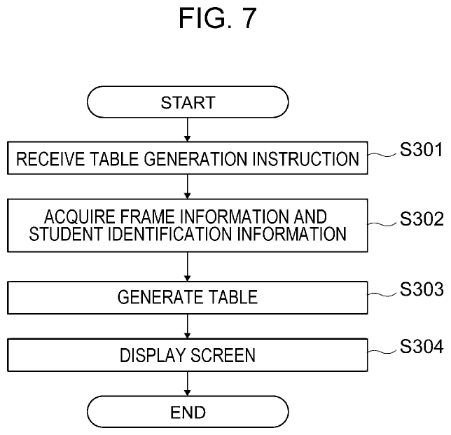

FIG. 7 is a flowchart illustrating a table creation process performed by the table creation unit 18. As described above, the report on each student may be generated with an image attached thereto for a predetermined time period. If some images that are to be used in the report are found to be missing in the report generation stage, it is difficult to respond to the problem. According to the exemplary embodiment, the table creation unit 18 is used to display the registration status for each student in response to a request. The registration status indicates information related to an amount of information on each student. The registration status may indicate the registration status only on the registration unit 16, may indicate the registration status on both the registration unit 16 and the additional registration unit 17, or may indicate the registration status only on the additional registration unit 17. The exemplary embodiment relates to a recognition unit, a holding unit, and a display. The recognition unit is an example of the face recognition unit 15 that recognizes a person that is captured in the video for the specific time period. The holding unit is an example of the registration unit 16 or the additional registration unit 17, each of which holds information concerning the person recognized by the recognition unit, and the specific time period. The display is an example of the PC 4 that displays information related to the amount of information held on the holding unit on a per person basis.

In the process of FIG. 7, the reception unit 12 in the server 1 receives via the PC 4 an instruction to create a table (S301). The table creation unit 18 obtains the frame information and the student identification information registered on the registration unit 16 (S302). The instruction to create the table includes information specifying an item included in the table. The information identifies the class, the school subject of a class session, and the like, and is an example of information that is received by the presentation unit. The information is also an example of information that identifies a group corresponding to the target. The table creation unit 18 creates table data using the obtained information (S303), and the PC 4 displays the table based on the table data (S304).

The table is referred to as a dashboard, and is used to know whether each student is registered on the registration unit 16 or not, and the number of registrations of the students. The item in one of a vertical direction and a horizontal direction of the table represents names of the students, and the item in the other of the vertical direction and the horizontal direction of the table represents a time axis (every day or every week), or the school subject of the class session. The instruction to create the table from the PC 4 may include an item selected from predetermined items. In such a case, the table is created using the selected item. The table may be displayed in connection with all students on each class. Alternatively, the table may be displayed in connection with some of the students.

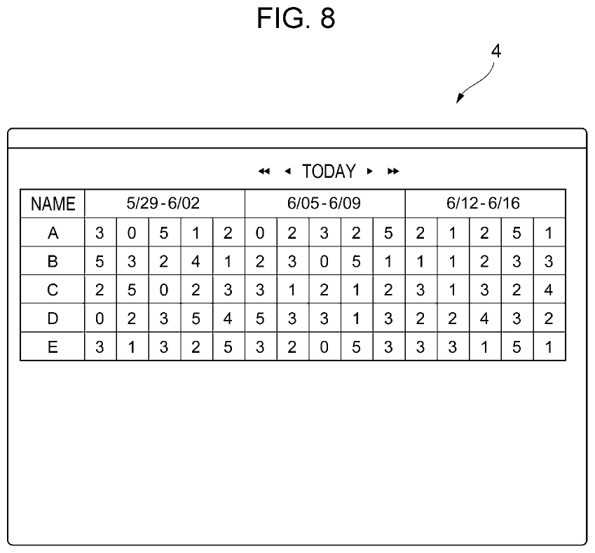

The table is specifically described. FIG. 8 is an example of the table and is displayed on the PC 4. Referring to FIG. 8, the horizontal direction is oriented from left to right in time sequence, and the vertical direction is oriented with the names of the students belonging to the class. The numbers of registrations performed on the registration unit 16 are displayed on each day on which each student has been registered. The teacher may confirm the registration status by periodically displaying the table. The teacher may also learn the number of images that are to be used in the report generation. For example, the teacher may pay attention to a student whose images are smaller in number in view of the rest of time, such that the number of images captured is increased by the creation of the report. FIG. 8 illustrates the table listing all the students belonging to the class. The table may be organized according to the school subject of the class session. The instruction to create the table listing the students of the class and the table listing the school subjects is an example of information identifying the group corresponding to the target.

In the display example of FIG. 8, if registrations are made on the registration unit 16, the number of the registrations is displayed. If no registration is made, “0” is displayed. The display form may be changed depending on whether each student is registered or not. The number “0” and other numbers may be displayed in different colors, or may be displayed in different sizes. For example, the number “0” is displayed in red color for emphasis, and the other numbers may be displayed in black. The number “0” may be displayed for emphasis in a size larger than the other number. The display form of the table may be selected depending on whether the student is face-registered by the face recognition unit 15 and stored on the registration unit 16 (face-recognized student) or the student is additionally registered by the additional registration unit 17 (additionally recognized student).

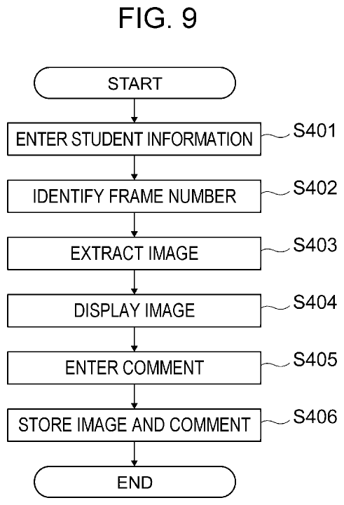

FIG. 9 is a flowchart illustrating the process performed by the report generation assisting unit 19. As described above, when the report with images is generated on each student, the image of the student to be attached to the report is to be found and selected in the stage of the report generation while the recorded video is referenced. The report generation thus takes time. According to the exemplary embodiment, an attribute (tag information) is imparted to the image through the registration to the registration unit 16. When the attribute is searched for, the image related to the attribute and an additive document (the student identification information) are displayed to facilitate an editing job. The exemplary embodiment relates to a display and an editing unit. The display is an example of the PC 4 that displays, when the attribute attached to the specific time period in the video is searched for, a set of the image related to the specific time period and the additive document related to the specific time period. The editing unit is an example of the PC 4 that edits the additive document.

In the process example of FIG. 9, when the teacher inputs the information on a target student (S401), the report generation assisting unit 19 in the server 1 refers to the student identification information registered on the registration unit 16, and identifies the frame number of the tagged video data in which the target student is captured (S402). The image of the student contained in the frame number is extracted (S403). The target image is thus extracted from the tagged video data.

If there are multiple student images, one is selected from the multiple images. For example, one image is selected when the report generation assisting unit 19 performs a predetermined process (automatic selection). The predetermined process herein may be a process of selecting on the entire image the largest image area where the target student is captured, or a process of selecting an image area where the number of students is smallest if the students excluding the target student are photographed. Also, the predetermined process may be a process of selecting an image area where the expression on the face of the target student satisfies a predetermined condition. The predetermined process also may further be a process of weighing multiple elements according to the degree of importance for assessment, and selecting an image. The elements, in this case, include the number of students photographed, an area where the target student is photographed, an expression on the target student's face, and the like. The report generation assisting unit 19 may display on the PC 4 images where the target student is captured, and the teacher may select one of the images (manual selection). In this way, the image of the student responsive to the assessment of the student may be selected in the report.

Turning to FIG. 9, the extracted student's image is displayed on the PC 4 (S404). A comment responsive to the student's image is input (S405). The report generation assisting unit 19 in the server 1 stores the student's image and the input comment in association with each other (S406).

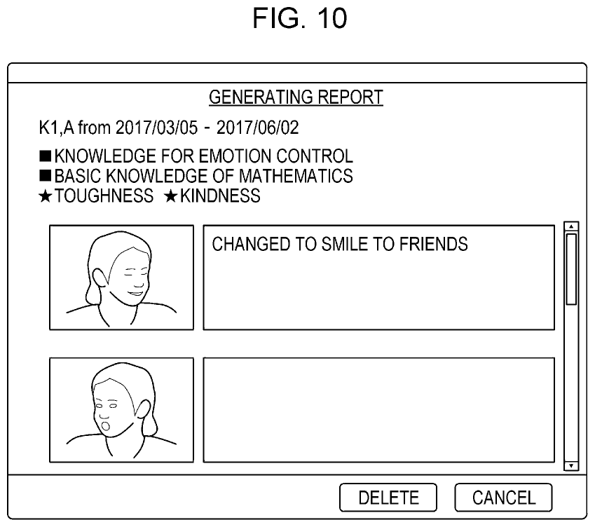

A report generation assisting process is specifically described. FIG. 10 is a display example on the PC 4 and illustrates an example of the report generation assisting process. In the display example of FIG. 10, the target student, target time period for a report and other information are displayed. An image where a student A is captured is displayed, and a comment box where the teacher may enter his or her comment is displayed in a corresponding region. Referring to FIG. 10, a comment reading “Changed to smile to friends” is entered. The information that the teacher inputs on the PC 4 is about the student A. The report generation assisting unit 19 automatically selects and displays the image where the student A is captured from among the images registered on the registration unit 16.

The video editing apparatus 100 of the exemplary embodiment includes the face recognition unit 15, in the server 1, which performs face recognition on a student that is captured in a video for a predetermined time period, the registration unit 16, in the server 1, which registers the student recognized by the face recognition unit 15 in association with the predetermined time period, and the PC 4 that displays, in response to the reception of the student identification information, the image in which the student associated with the time period and identified by the student identification information is recognized. The video editing apparatus 100 of the exemplary embodiment includes the face recognition unit 15, in the server 1, which performs face recognition on the student that is captured in the video for the predetermined time period, the registration unit 16, in the server 1, which registers the student recognized by the face recognition unit 15, and the PC 4 that indicates, in response to the reception of class information, whether the student identified by the class information is registered on the registration unit 16. The video editing apparatus 100 of the exemplary embodiment includes the face recognition unit 15, in the server 1, which performs face recognition on the student that is captured in the video for the predetermined time period, the registration unit 16, in the server 1, which registers the student recognized by the face recognition unit 15, and the additional registration unit 17 that additionally registers on the registration unit 16 a student who is specified as not being recognized by the face recognition unit 15.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. A video editing apparatus comprising:
a recognition unit that recognizes a target that is captured in a video for a predetermined time period;
a registration unit that registers therein the target, recognized by the recognition unit, in association with the predetermined time period; and
a display that displays, in response to reception of information, an image in which the target associated with the predetermined time period and identified by the information is recognized.

2. The video editing apparatus according to claim 1, further comprising a selection unit that selects, if a plurality of images from which the target associated with the predetermined time period is recognized are present, one of the images.

3. The video editing apparatus according to claim 2, wherein the selection unit selects as the one of the images an image from among the images that satisfies a predetermined condition.

4. The video editing apparatus according to claim 2, wherein the selection unit selects as the one of the images an image from among the images that is specified by a user.

5. A video editing apparatus comprising:
a recognition unit that recognizes a target that is captured in a video for a predetermined time period;
a registration unit that registers therein the target recognized by the recognition unit; and
a presentation unit that indicates, in response to reception of information, whether the registration unit has registered the target identified by the information.

6. The video editing apparatus according to claim 5, wherein the information identifies a group corresponding to the target, and
wherein the presentation unit, indicating whether the registration unit has registered the target, identifies the target by the group.

7. The video editing apparatus according to claim 6, wherein the group is a school class to which the target belongs.

8. The video editing apparatus according to claim 6, wherein the group is a school subject of a class session that the target takes.

9. The video editing apparatus according to claim 5, wherein the presentation unit changes a presentation form from the target registered by the registration unit to the target not registered by the registration unit.

10. The video editing apparatus according to claim 5, wherein the presentation unit indicates the targets in a presentation form by placing a more emphasis on the target not registered by the registration unit than on the target registered by the registration unit.

11. A video editing apparatus comprising:
a recognition unit that recognizes a target that is captured in a video for a predetermined time period;
a registration unit that registers therein the target recognized by the recognition unit; and
an addition unit that additionally registers in the registration unit the target that is specified as not being recognized by the recognition unit.

12. The video editing apparatus according to claim 11, wherein the addition unit registers the target, which is to be additionally registered, together with the target recognized by the recognition unit.

13. The video editing apparatus according to claim 12, wherein the registration unit registers information that differentiates the target recognized by the recognition unit from the target additionally registered by the addition unit.
